(19) United States
(12) Patent Application Publication
(10) Pub. No.: US 2021/0064050 A1
(43) Pub. Date: Mar. 4, 2021

(54) METHODS AND APPARATUS TO RECORD AND EXECUTE MISSION PLAN

(71) Applicant: Deere & Company, Moline, IL (US)

(72) Inventors: Terence D. Pickett, Waukee, IA (US); Qiang R. Liu, Urbandale, IA (US); Daniel R. Smith, Ankeny, IA (US)

(21) Appl. No.: 16/999,854

(22) Filed: Aug. 21, 2020

Related U.S. Application Data
(60) Provisional application No. 62/894,431, filed on Aug. 30, 2019.

(51) Int. Cl. G05D 1/02; A01B 69/00; G05D 1/00

(52) U.S. Cl. CPC G05D 1/0223; A01B 69/004; G05D 2201/0201; G05D 1/0219; G05D 1/0044

(57) ABSTRACT

Methods, apparatus, and systems are disclosed to record and execute mission plans. An example apparatus includes a data collection memory to collect first and second data, the first data corresponding to a machine and the second data corresponding to an implement, a mission aggregator to determine a machine path based on the first data, determine an implement path based on the second data, and determine a machine speed and an implement action based on the first and second data, a mission generator to generate a three-dimensional mission plan including the machine path, the implement path, the machine speed, and the implement action for subsequent use, and a mission application controller to, when an interface determines the mission plan is available, instruct the machine and the implement to follow the machine path, the implement path, the machine speed, and the implement action to execute the mission plan.

### RELATED APPLICATION

This patent arises from a continuation of U.S. Provisional Patent Application Ser. No. 62/894,431, which was filed on Aug. 30, 2019. U.S. Provisional Patent Application Ser. No. 62/894,431 is hereby incorporated herein by reference in its entirety. Priority to U.S. Provisional Patent Application Ser. No. 62/894,431 is hereby claimed.

### FIELD OF THE DISCLOSURE

This disclosure relates generally to mission plans, and, more particularly, to record and execute a mission plan in a field environment.

### BACKGROUND

Several general operations are required during a crop farming season. Depending on the crop farming culture, the common operations are cultivation, seeding, fertilizing, chemical treatment, and harvesting. A tractor is a general-purpose power machine that has an associated set of tools available for each operation. These tools, in which can be connected to the tractor, are commonly referred to as implements.

### BRIEF DESCRIPTION OF THE DRAWINGS

FIGS. 1A and 1B depict an example agricultural vehicle to execute an agricultural operation on the field plot.

FIG. 2 depicts a block diagram of an example mission planning apparatus to employ the agricultural vehicle to execute the agricultural operation on the field plot.

FIG. 3 is a display depicting an example user interface of the mission planning apparatus illustrated in FIG. 2.

FIG. 4 is a block diagram depicting the example mission recorder to employ the mission planning apparatus of FIG. 2.

FIG. 5 is a flowchart representative of machine readable instructions which may be executed to implement the example mission recorder and mission applicator illustrated in FIGS. 2 and 4.

FIG. 7 is a flowchart representative of machine readable instructions which may be executed to implement the example mission applicator illustrated in FIGS. 2.

FIG. 8 is a flowchart representative of machine readable instructions which may be executed to implement the example mission planning apparatus illustrated in FIG. 2.

In general, the same reference numbers will be used throughout the drawing(s) and accompanying written description to refer to the same or like parts. Descriptors “first,” “second,” “third,” etc. are used herein when identifying multiple elements or components which may be referred to separately. Unless otherwise specified or understood based on their context of use, such descriptors are not intended to impute any meaning of priority or ordering in time but merely as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

### DETAILED DESCRIPTION

An agricultural field plot is an area of land in which farmers plant crops or pasture their animals. In recent years, total acreage of field plots per farmer has increased. Traditionally, a farmer plants crops on a field plot by driving a machine (e.g., a tractor) with implements across the field plots based on the farmer's experience with land. In some examples, farmers use maps, memory, global positioning systems (GPS), etc. to drive the machine across the field plot in order to ensure total coverage of the field plot for optimal use.

Due to labor shortages, high turnover rates, and an increase in total acreage per farmer, some field plots are cultivated by a farmer that is unfamiliar with the land. While experienced farmers will be able to look at a field plot and determine an optimal path by which a machine can traverse the field plot, the non-experienced farmers may not be able to determine an optimal path, and therefore time, land, and crops are wasted on a field plotted by an inexperienced farmer.

A mission plan is useful to overcome the challenges mentioned above. A mission plan is a predetermined plan of action a farmer utilizes to perform one or more of the operations of agricultural farming in an efficient manner. A mission plan includes path planning, wherein the path planning includes determining a path for the machine to follow during harvesting, seeding, cultivating, fertilizing, and chemical treatment.

However, in some examples, path planning involves more than just finding a path that covers a field plot. For example, some input may be delivered (e.g., planting seeds) to the field or some output is harvested from the field (e.g., crops are gathered from the field) and the machines cannot carry an infinite amount of input (e.g., seeds) or output (e.g., crops). Accordingly, the machines have to be refilled or emptied regularly. This part of operation should be taken into consideration when path planning. Another example is that a path plan should take the natural contours (e.g., slopes, valleys, hills) of the land into account when performing some operations (e.g., planting) because of waterflow, ditches, straight planting lines, etc. A mission plan may be executed erroneously by an agricultural machine when an operator does not know the natural contours of the land, thereby causing the agricultural field to be destroyed, seeds to be planted in an area that is not fertile, etc.

Example methods and apparatus disclosed herein generate a three-dimensional (3D) map of the field for farmers to know precise locations of where to seed, spray, harvest, etc. so that the agricultural operation is executed as intended. Example methods and apparatus described herein utilize GPS receiver(s) to gather altitude, latitude, and longitude data of the machine and/or the implement, wherein the GPS receivers are located on the machine and/or implement.

A mission plan also includes actions taken by the machine and implement. In some examples, an action is turning off and turning on a sprayer during the fertilization operation, raising or lowering an implement, etc. A mission plan may include the speed of the machine at each location of the field. For example, a farmer may need to determine the speed of the machine when turning, when going up and down a slope of the field, etc. Example methods and apparatus disclosed herein generate mission plans for, experienced or inexperienced farmers. In some examples, the mission plan includes the speed and actions taken by a machine and/or implement during an agricultural operation performed on a field plot.

Lately, auto-guidance devices have become common in agricultural field machines. An auto-guidance device is installed on the machine and it may automatically (e.g., electro-hydraulic steering) or semi-automatically (e.g., a light bar to show steering request) keep the vehicle on-lane based on satellite positioning. In some examples, the auto-guidance machines need to follow previously created guidance lines of a field plot in order to execute an operation such as seeding, fertilizing, etc. Example methods and apparatus disclosed herein record the machine path and/or the implement path when an experienced farmer drives the field plot for the first time and saves the plot to a local memory for future use by an auto-guidance device. For example, when an experienced farmer executes a planting operation, methods and apparatus disclosed herein record the path the farmer takes along with the speed at each location and the action taken at each location. The recorded path, speed, and actions are applied to a map and saved in a local database or memory for future use by the auto-guidance device of the machine.

As used herein, the term “working width” is the width between two crop rows of a planted seed, wherein there are a plurality of crop rows, and the widths between each are the working widths.

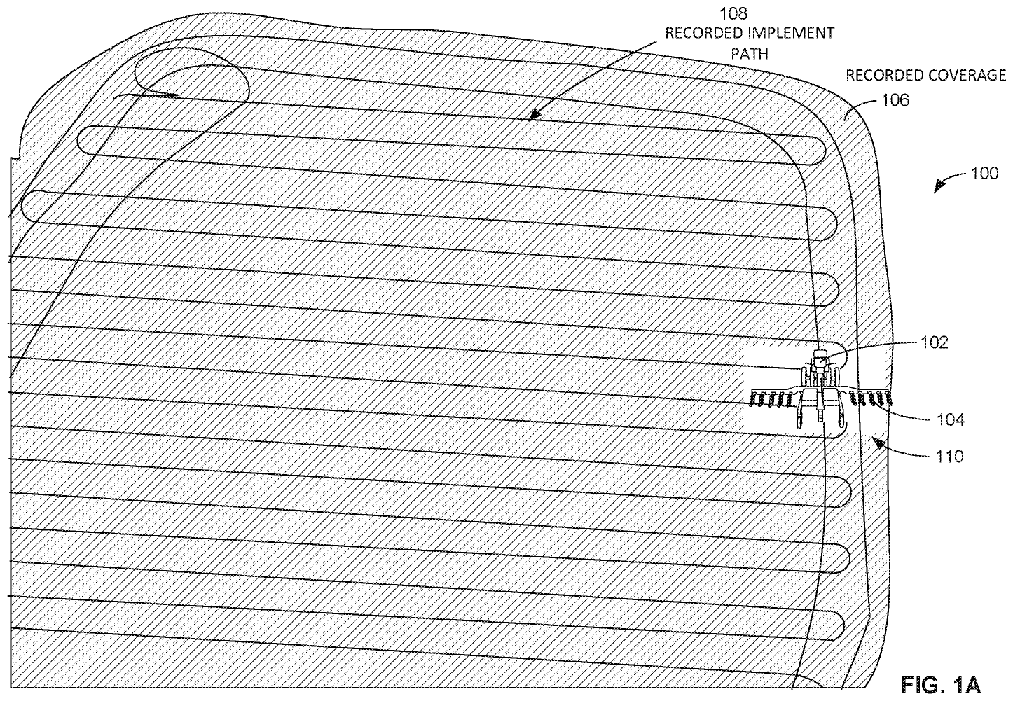

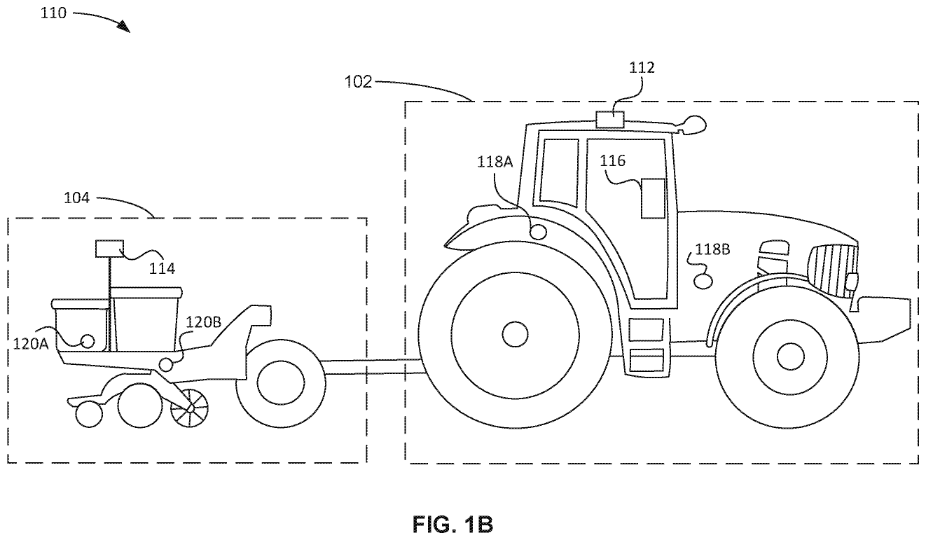

FIG. 1A illustrates an example field plot 100 in which agricultural operations are executed on. In FIG. 1A, the example field plot 100 is shown to include an example agricultural vehicle 110. The example agricultural machine 110 includes an example machine 102 and an example implement 104. The example field plot 100 includes an example recorded coverage area 106 and an example recorded implement path 108. The example field plot 100 is at a location and may include a location name. For example, the field plot 100 may be named “Creek Field” and such a location name is determined by the executer of agricultural operations on the field, such as a farmer, an agricultural company, a family, etc. The example field plot 100 may include hills, slopes, dips, rocks, etc. that are not illustrated but that are taken into account by examples disclosed herein.

FIG. 1B illustrates the example agricultural vehicle 110 including the example machine 102 and the example implement 104. In FIG. 1B, the machine 102 pushes and/or pulls agricultural machinery (e.g., the implement 104), trailers for plowing, tilling, disking, harrowing, planting, etc. In some examples, the machine 102 is a tractor operated by a user or self-operated (e.g., by an auto-guidance device). The machine 102 includes an example machine receiver 112, an example mission planning system 116, an example first sensor 118A, and an example second sensor 118B.

The example machine 102 includes the example machine receiver 112 to determine precise location information about the machine 102. In the illustrated example, the machine receiver 112 is located on the roof of the machine 102. In other examples, the machine receiver 112 may be located on the front end or back end of the machine 102. In some examples, there may be a plurality of machine receivers 112 located on a plurality of areas of the machine 102.

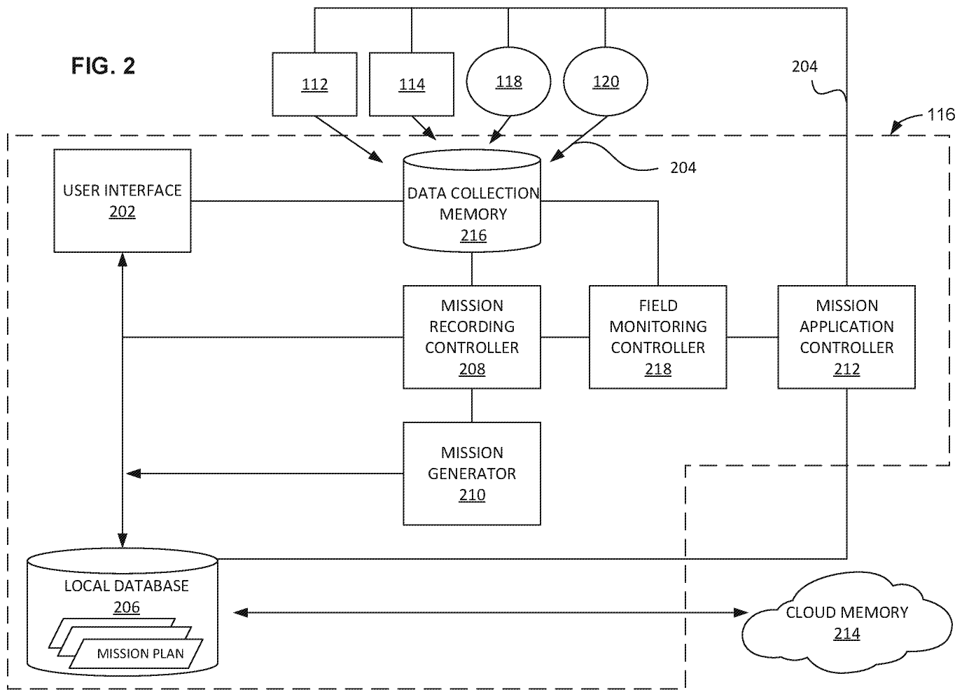

The example machine 102 includes the example mission planning system 116 to allow a user to operate the machine 102, visualize (e.g., see) the recorded coverage area 106 and the implement path 108 of the field plot 100, and determine the mission plan to execute the agricultural operation. The example mission planning system 116 is illustrated as located inside the machine 102. Additionally and/or alternatively, the mission planning system 116 may be located in an off-site office, building, home, vehicle, etc., in which a user can control the machine 102 (e.g., a self-operating machine). The example mission planning system 116 is described in further detail below in connection with FIGS. 2-7.

The example machine 102 includes the example machine sensors 118 or the example first sensor 118A and second sensor 118B, to monitor the environment of the machine 102. In some examples, the machine sensors 118 may include temperature sensors to monitor devices operating the machine 102, lidars to detect movement around the machine 102 and the distance of objects near the machine 102, accelerometers to measure acceleration of the machine 102, etc. For example, the first sensor 118A may be an accelerometer to monitor the acceleration of the machine 102. The second sensor 118B may be a lidar located on the side of the machine 102 to detect obstacles or objects located a specific distance away from the machine 102.

If the machine 102 is self-operated, the machine 102 may include devices and controllers that program the machine 102 to independently observe its position, decide its speed, and avoid obstacles (e.g., animals, humans, objects in the field plot 100, etc.). Examples of devices operating a self-operated machine include but are not limited to dome antennas, a controller area network (CAN) bus, GPS receivers, a server (e.g., the local database 206), a user interface (e.g., a user interface 202), and a plurality of sensors including the first sensor 118A and second sensor 118B (e.g., lidar, accelerometer, laser, ultrasonic, distance, temperature, infrared, etc.). As used herein, a CAN bus is a bus designed to enable microcontrollers and devices to communicate with each other in applications without a host computer.

In FIG. 1B, the example agricultural vehicle 110 includes the implement 104 to perform the agricultural operation. For example, the implement 104 is/are a piece or pieces of equipment connected to the machine 102 that do the work on the example field plot 100 (FIG. 1A) such as seeding, spraying, tilling, etc. In FIG. 1B, the example implement 104 is illustrated as a planter. Additionally or alternatively, the example implement 104 may be a sprayer, tillage equipment, or an implement of different size and or/shape as the illustrated implement 104. The example implement 104 includes an example implement receiver 114, an example third sensor 120A, and an example fourth sensor 120B.

The example implement 104 includes the implement receiver 114 to determine precise location information about the implement 104. For example, the implement receiver 114 tracks the path or route in which the planter travels along the field plot 100. The example implement receiver 114 is located above the planter units. In some examples, the implement receiver 114 may be located in an area on the implement 104 different than the illustrated in FIG. 1B. In some examples, if there are a plurality of planter units connected to form the implement 104, there may be a plurality of implement receivers 114 located on each planter unit.

The example implement 104 includes the example implement sensors 120. When referring to the implement sensors 120, it should be understood that the description of the implement sensors 120 may also be used to describe the third sensor 120A and the fourth sensor 120B of FIG. 1B. The example implement sensors 120 monitor the environment of the example implement 104. In some examples, the implement sensors 120 may be similar to the sensors of the machine 102, however, they monitor the operation of the implement 104. For example, the third sensor 120A is a liquid level sensor to measure the amount of fertilizer in the fertilizer bin. In some examples, the fourth sensor 120B is an accelerometer that measures the acceleration of the implement 104. In some examples, there may be implement receivers located on every other planter (e.g., if the implement 104 includes a plurality of planters) for accurate and precise data pertaining to the location of each planter. If the right side of a planter bar is being driven along the side of a slope or hill on the example field plot 100, then the right side of the planter bar may sag or have a lower altitude than the left side of the planter bar, and therefore the GPS receivers located across the planter bar record that information to provide to the user for feedback, accuracy checks, and future users performing a mission on that field plot 100.

The example sensors 118A, 118B, 120A, and 120B and the example receivers 112, 114 of the example agricultural vehicle 110 store data (e.g., sensor data collected during a mission) in a storage database of the example machine 102, an example cloud memory 214, etc. In some examples, the mission planning system 116 analyzes the data obtained by the receivers 112, 114 and the sensors 118A, 118, 120A, and 120B to generate and perform mission plans.

Returning to FIG. 1A, the example field plot 100 includes the recorded coverage area 106 to indicate the area of the field plot 100 that has been covered by the machine 102. The example recorded coverage area 106 is illustrated by dashed lines. The recorded coverage area 106 of the field indicates the area in which seeds were planted, where crops were sprayed, etc. The example recorded coverage area 106 is displayed on a map that is provided to a user to inform the user if they need to continue agricultural operations in a different section of the field plot 100.

FIG. 2 illustrates an example mission planning system 116 in connection with an example cloud memory 214, the example receivers 112, 114, and the example sensors 118, 120 to record and execute a mission plan of an agricultural operation. The example mission planning system 116 includes an example user interface 202, the example local database 206, an example mission recording controller 208, an example mission generator 210, an example mission application controller 212, an example data collection memory 216, and an example field monitoring controller 218.

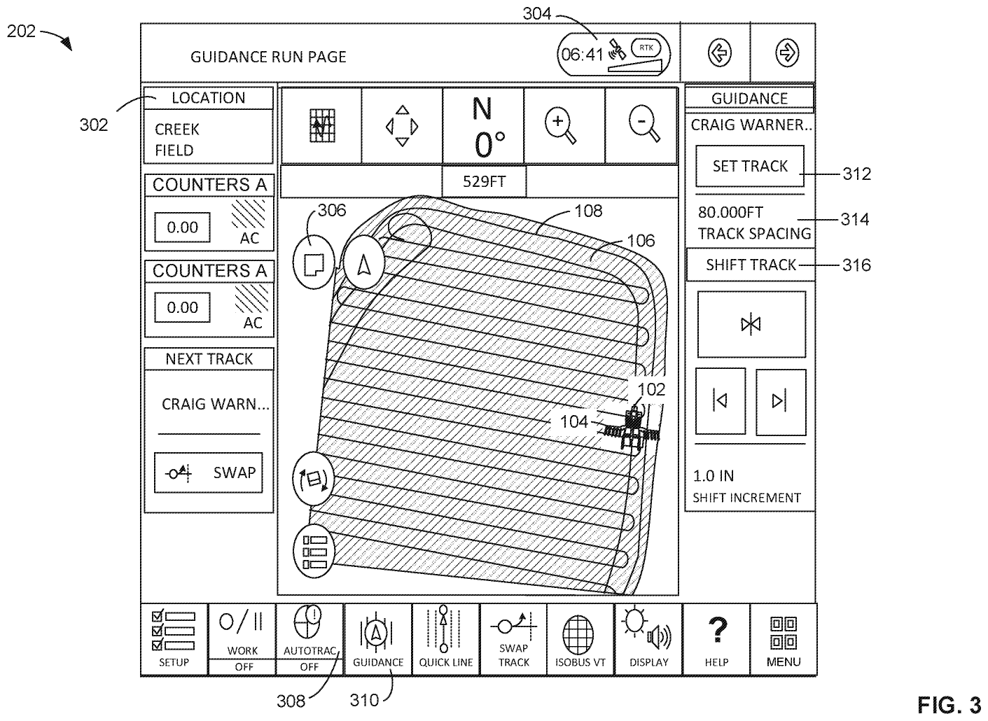

In FIG. 2, the example mission planning system 116 includes the example user interface 202 to retrieve a mission plan from the example local database 206 and generate instructions corresponding to the mission plan for use by the user operating the agricultural vehicle 110. For example, the user interface 202 receives an input (e.g., a request) from a user (e.g. a farmer, an equipment operator, etc.). The user interface 202 provides a notification to initiate the mission recording controller 208, query the local database 206, initiate the mission application controller 212, etc. For example, the user may interact with and/or select an interactive “on” button, in which the user interface 202 initiates the mission recording controller 208 to initiate all of the devices associated with recording the mission. The example user interface 202 is, but not limited to, a liquid crystal display touch screen such as a tablet, a Generation 4 CommandCenter™ Display, a computer monitor, etc. The example user interface 202 is described in further detail below in connection with FIG. 3.

In FIG. 2, the example mission planning system 116 includes the example local database 206 to store, organize, and manage the data collected from the data collection memory 216, the user interface 202, the mission recording controller 208, the mission generator 210, and the mission application controller 212. The example local database 206 may be a memory of the mission planning system 116 located on the machine 102. In some examples, the local database 206 is separate of the example mission planning system 116 and obtains data wirelessly via a network from the receivers 112, 114 and sensors 118A, 118B, 120A, 120B.

In FIG. 2, the example mission planning system 116 includes the example mission recording controller 208 to record a 3D mission plan of an agricultural operation on the example field plot 100. In some examples, the mission recording controller 208 obtains a control message and/or notification from the user interface 202 that a user has triggered and/or initiated the machine 102 and implement 104 to drive the field plot 100. In response to the control message, the mission recording controller 208 begins the process of recording the machine 102 path, the implement 104 path, the actions of the implement 104, and the speed of the machine 102. For example, a user is planting seeds in the field plot 100 using the machine 102 to pull the implement 104 across the field plot 100. In such an example, the implement 104 is a 30 planter row unit (e.g., a bar with 30 row units in a horizontal row attached to the back side of the machine 102) with an implement receiver 114 coupled to each planter.

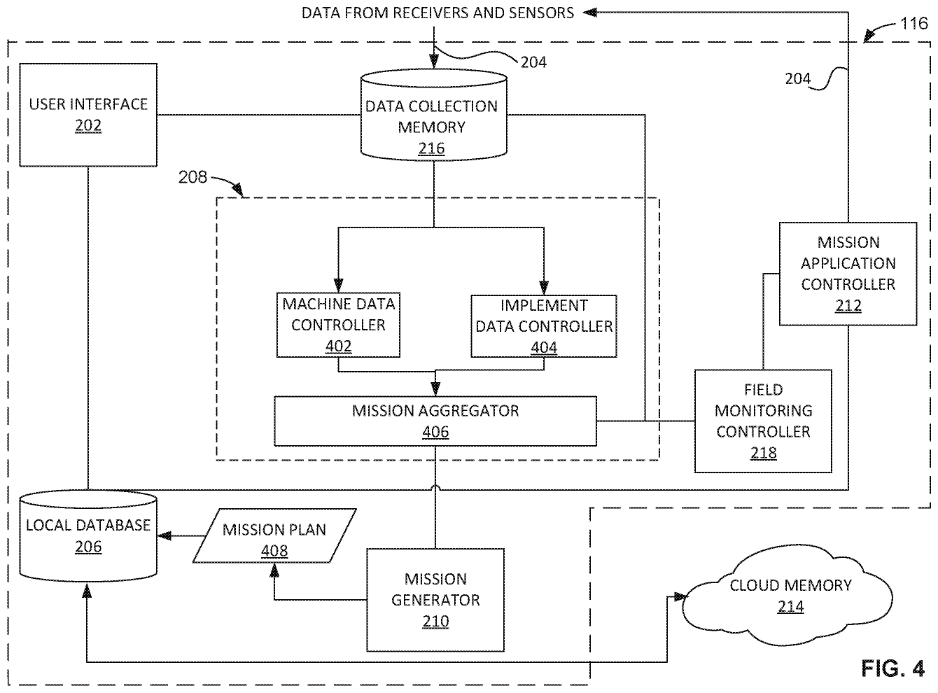

The example receivers 114 store data, generated during planting, at the data collection memory 216. In some examples, the mission recording controller 208 obtains data from the data collection memory 216 and stores it in the local database 206 during the movement and actions of the machine 102 and implement 104. In other examples, the mission recording controller 208 records the 3D mission utilizing the data from the receivers 114 and/or the receiver 112, the sensors 118, 120, etc. The example mission recording controller 208 is described in further detail below in connection with FIG. 4.

In FIG. 2, the example mission planning system 116 includes the example mission generator 210 to produce and/or generate a report of the mission plan recorded by the example mission recording controller 208. In some examples, the report may be a 3D map of the mission plan including a header, a footer, notes, and sections that inform the user the actions taken at different parts of the path on the map. In some examples, the mission generator 210 provides real-time reporting to a user via the user interface 202 during the mission. For example, the mission recording controller 208 records the mission based on the data generated from the machine 102 and implement 104 as the agricultural vehicle 110 is working. The example mission recording controller 208 provides the recorded mission to the mission generator 210 in real-time (e.g., the actual time in which a process or event occurs). In this manner, the example mission generator 210 generates the recorded mission as a mission plan, stores the mission plan in the local database 206, and simultaneously provides the mission plan to the example user interface 202.

In FIG. 2, the example mission planning system 116 includes the example mission application controller 212 to execute a mission plan utilizing the devices operating the example machine 102 and the example implement 104. The example mission application controller 212 is coupled to the devices of the example machine 102 and the example implement 104 via the CAN bus 204. In some examples, the mission application controller 212 may be coupled to the devices and controllers of the machine 102 and implement 104 via Bluetooth, RFID, Zigbee, etc.

In operation, the example mission application controller 212 obtains the mission plan, recorded and stored by the example mission recording controller 208, from the example local database 206 and generates instructions that replicate the instructions provided in the mission plan. For example, the mission application controller 212 determines instructions to be generated for the machine 102 and implement 104 based on the mission plan. The mission application controller 212 determines the location on the field plot 100 where each instruction should be applied. For example, the mission application controller 212 provides instructions to the devices operating the machine 102 and the implement 104, such as the example sensors 118, 120 coupled to machine hardware and the example receivers 112, 114, that provide information about the actions and path to take on the field plot 100, the speed to perform the actions and drive the path, etc. In some examples, the mission application controller 212 obtains a notification from the user interface 202 that a user has found a mission plan for planting in the field plot 100 and requests to use the mission plan to execute the agricultural operation.

In FIG. 2, the example mission planning system 116 includes the example field monitoring controller 218 to determine if the example field plot 100 has been covered by the example agricultural vehicle 110. In some examples, the field monitoring controller 218 determines the time (e.g., minutes, hours, etc.) it takes the example agricultural vehicle 110 to complete the mission. For example, the field monitoring controller 218 queries the data collection memory 216 for location data from the receivers 112, 114 to determine area of the field plot 100. In other examples, the field monitoring controller 218 may find the area of the field plot 100 based on the location and name of the field determined by the user interface 202 (described in connection with FIG. 3) and retrieve the machine receiver 112 and implement receiver 114 data to determine the locations of the field plot 100 that have been recorded and have not been recorded. In this manner, the example field monitoring controller 218 determines the time remaining to complete the mission and the area of the field plot 100 that has not been covered.

In FIG. 2, the example mission planning system 116 includes the example data collection memory 216 to cache (e.g., store) data from the receivers and sensors (e.g., receivers 112, 114 and sensors 118, 120) of the agricultural vehicle 110. The example data collection memory 216 may be a cache, an extended memory, a memory, a storage database, an example volatile memory 814, the example non-volatile memory 816, or any other type of structured collection of data that can be accessed by a computer system and stores data for a period of time (e.g., until the mission recording controller 208, user interface 202, and/or field monitor 118 requests for the stored data). The example data collection memory 216 stores data from the receivers 112, 114 and from the sensors 118, 120 via the CAN bus 204. In some examples, the data collection memory 216 obtains data wirelessly. The machine receiver 112 and the implement receiver 114 provide real-time data to the example data collection memory 216, such as location (e.g., a longitude and latitude numeric value), velocity (e.g., numeric value representing how many meters per second the user is driving the machine 102), and time. The example sensors 118, 120 store data at the data collection memory 216 with a timestamp to associate the measurements with an exact time. For example, if an accelerometer measured an acceleration of the implement 104 at time 1, then that measurement (e.g., a numerical value) may be provided to the data collection memory 216 and tagged with the timestamp of t1. In this manner, the example data collection memory 216 can identify the data before evicting it to the example mission recording controller 208. In other examples, the data collection memory 216 associates the data with time for use by the mission recording controller 208.

In FIG. 2, the example mission planning system 116 includes the cloud memory 214 to store mission plans on remote servers. The cloud memory 214 accesses the mission plans from the remote servers via the Internet. The example cloud memory 214 is similar to the example local database 206 with the exception that it is a virtual database and therefore, hardware is not required to collect the stored data. For example, if the mission planning system 116 has recorded hundreds of mission plans and the local database 206 can only store up to 50 mission plans, the local database 206 will offload the excess mission plans and/or all mission plans to the cloud memory 214. In some examples, a user obtains a mission plan from the cloud memory 214 when operating a self-operated machine 102 from a remote office.

FIG. 3 illustrates the example user interface 202 to provide options, directions, information, and control to the user operating the example machine 102 and the example implement 104. The example user interface 202 of FIG. 3 is the Generation 4 CommandCenter™ Display and includes a plurality of interactive input controls to allow a user to operate the example machine 102 and the example implement 104. The example user interface 202 displays the example field plot 100, an image of the example machine 102, an image of the example implement 104, the example recorded coverage area 106, and the example recorded implement path 108. The example user interface 202 further includes an example field input 306, an example autotrac input 308, an example guidance input 310, and an example set track input 312.

In FIG. 3, the user interface 202 includes the field input 306 to indicate the field in which a user is working on. The example field input 306 includes field names to organize information to find and use data, such as guidance lines (e.g., lines in which the machine 102 and/or implement 104 are to follow). The example field input 306 is also used to set up clients, farms, and fields. For example, a provider or manufacturer can input a plurality of field names, client names, and farm names into the local database 206 for the user interface 202 to retrieve when the user wants to set their current location. The example field input 306 utilizes the GPS receivers located on the example machine 102 and the example implement 104 to determine the location. In some examples, when the user selects the field via the field input 306, the field name is displayed in the location section 302 of the user interface 202. For example, the location section 302 displays the name “Creek Field” to indicate that the example field plot 100 is that particular location. If the user determines that the example field plot 100 is not “Creek Field,” they may select the field input 306 and update the location.

In FIG. 3, the user interface 202 includes the autotrac input 308 that, when activated, allows the user to take their hands off the steering wheel while the example machine 102 travels down the created guidance lines in the example field plot 100. For example, the autotrac input 308 is an assisted steering system that utilizes the hydraulic system in a machine 102 to multiply force applied to the steering wheel inputs to the example machine 102 wheels. In some examples, if a user selects the autotrac input 308, the user can be hands-free on the steering wheel unless the machine 102 has to make a turn, in which case the user rotates the steering wheel in the direction of the turn. When the autotrac input 308 is activated, the example machine 102 follows the guidance lines set by the example guidance input 310.

In FIG. 3, the user interface 202 includes the guidance input 310 to steer the machine 102 through the example field plot 100 along the guidance tracks. In some examples, the user chooses a mission plans and the mission plan provides guidance tracks that follow the mission plan. The display of the user interface 202 may show the path in which the user is to steer the machine 102 or in which the machine 102 is to steer itself

In some examples, if the machine 102 is self-operated, it may shift off track due to GPS drift. As used herein, GPS drift is the condition where the positional information that is obtained from the GPS satellites moves over time. The shift track input 316 moves track zero (e.g., the reference path) and the tracks associated with it left or right the distance specified in “Shift Increment” display with each press (e.g., selection, interaction, etc.).

The example user interface 202 is not limited to the interactive inputs disclosed herein. The example user interface 202 may include any number of options in which a user can utilize to complete a mission for a field plot. The example interactive inputs disclosed herein and not disclosed herein correspond to instructions that, when activated, notify a processor such as the example processor 812 of the example processor platform 800, to perform the instructions.

FIG. 4 is a block diagram that employs the example mission recording controller 208 of the example mission planning system 116 to record a mission of an agricultural operation performed on the example field plot 100. The example mission recording controller 208 includes an example machine data controller 402, an example implement data controller 404, and an example mission aggregator 406. FIG. 4 illustrates the example user interface 202, the example local database 206, the example mission generator 210, the example mission application controller 212, the example data collection memory 216, and the example field monitoring controller 218.

In FIG. 4, the example mission recording controller 208 includes the example machine data controller 402 and the example implement data controller 404 to correlate the data corresponding to the machine 102 (e.g., the data from the machine receiver 112 and the machine sensors 118) and the data corresponding to the implement 104 (e.g., the data from the implement receiver 114 and the implement sensors 120). For example, the machine data controller 402 may query the data collection memory 216 for the data from the machine receiver 112 and machine sensors 118 at times t1, t2, and t3 and associate the data before providing it to the mission aggregator 406. In some examples, the implement data controller 404 may query the data collection memory 216 for the implement receiver 114 data and implement sensors 120 data at a time different than the machine data controller 402 queried or at the same time. In other examples, the data collection memory 216 may dump data to the mission recording controller 208 in an unorganized manner, and the machine data controller 402 and implement data controller 404 perform association operations to properly correlate the data with respective times and categories.

In some examples, the example machine data controller 402 and implement data controller 404 analyze the data from the example data collection memory 216. For example, the machine data controller 402 may remove redundant data, inconsistent data, and corrupt data before providing it to the mission aggregator 406 for the purpose of generating consistent and well-structured mission plan. In some examples, the machine data controller 402 may tag the data with metadata so that the mission aggregator 406 can properly aggregate the data corresponding to the machine 102 and the data corresponding to the implement 104. For example, the machine data controller 402 may tag the accelerometer data from the machine sensor 118B with a different tag than the accelerometer data from the implement sensor 120B.

In FIG. 4, the example mission recording controller 208 includes the example mission aggregator 406 to aggregate the data from the machine data controller 402 and the implement data controller 404 to form a layout (e.g., a map, an image, etc.) for the example mission generator 210. For example, the mission aggregator 406 may overlay the speed data pertaining to the machine 102 in a section of the layout labeled “Speed” to show the user how many miles per hour the machine driving. In other examples, the mission aggregator 406 may overlay the data from the machine receiver 112 and the implement receiver 114 to form a path on the layout indicating the location of the machine 102 and implement 104. The example mission aggregator 406 provides the aggregated data to the example mission generator 210 to generate the layout as a map with sections, headers, and values such as the map illustrated in the user interface 202 display shown in FIG. 3. In some examples, the mission aggregator 406 sends a notification to the field monitoring controller 218 to query the data collection memory 216 determining if the field plot 100 has been completed (e.g., the recorded coverage area 106 illustrates the entire field plot 100, not just a section of it).

In FIG. 4, the example mission recording controller 208 includes the example mission generator 210 to retrieve the aggregated and organized data from the mission aggregator 406 and generate a mission plan 408 (e.g., a map). The example mission generator 210 may provide the example mission plan 408 to the local database 206 via the example bus 204. The example mission generator 210 may provide a complete mission plan 408 to the local database 206, where the complete mission plan 408 includes a path (e.g., guidance lines) of the machine 102 and the implement 104, actions that were taken by the implement 104 at the time and location, and the speed of the machine 102 at the time and location. The report generated by the example mission generator 210 includes x data (e.g., latitude), y-data, (e.g., longitude), and z-data (e.g., altitude) wherein the z-data accounts for the slopes, hills, and valleys of the agricultural field. The mission generator 210 may generate the mission plan 408 as a bundle of instructions, location data (e.g., latitude, longitude, and altitude), field plot 100 information (e.g., if the machine 102 and/or implement 104 drove across hills, valleys, slopes, etc.), and any other type of information that corresponds to the agricultural operation performed by the machine 102 and implement 104. The mission plan 408 is also represented visually by the user interface 202 to show an operator executing the mission the path that the example machine 102 and the example implement 104 should follow.

While an example manner of implementing the mission planning system 116 of FIG. 1B is illustrated in FIGS. 2-4, one or more of the elements, processes and/or devices illustrated in FIGS. 2-4 may be combined, divided, re-arranged, omitted, eliminated and/or implemented in any other way. Further, the example user interface 202, the example mission recording controller 208, the example mission generator 210, the example mission application 212, the example field monitoring controller 218, the example field input 306, the example autotrac input 308, the example guidance input 310, the example set track input 312, the example machine data controller 402, the example implement data controller 404, the example mission aggregator 406, and/or, more generally, the example mission planning system of FIG. 1B may be implemented by hardware, software, firmware and/or any combination of hardware, software and/or firmware. Thus, for example, any of the example user interface 202, the example mission recording controller 208, the example mission generator 210, the example mission application 212, the example field monitoring controller 218, the example field input 306, the example autotrac input 308, the example guidance input 310, the example set track input 312, the example machine data controller 402, the example implement data controller 404, the example mission aggregator 406 and/or, more generally, the example mission planning system 116 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one oft the example user interface 202, the example mission recording controller 208, the example mission generator 210, the example mission application 212, the example field monitoring controller 218, the example field input 306, the example autotrac input 308, the example guidance input 310, the example set track input 312, the example machine data controller 402, the example implement data controller 404, and/or the example mission aggregator 406 is/are hereby expressly defined to include a non-transitory computer readable storage device or storage disk such as a memory, a digital versatile disk (DVD), a compact disk (CD), a Blu-ray disk, etc. including the software and/or firmware. Further still, the example mission planning system 116 of FIG. 1B may include one or more elements, processes and/or devices in addition to, or instead of, those illustrated in FIGS. 2-4, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

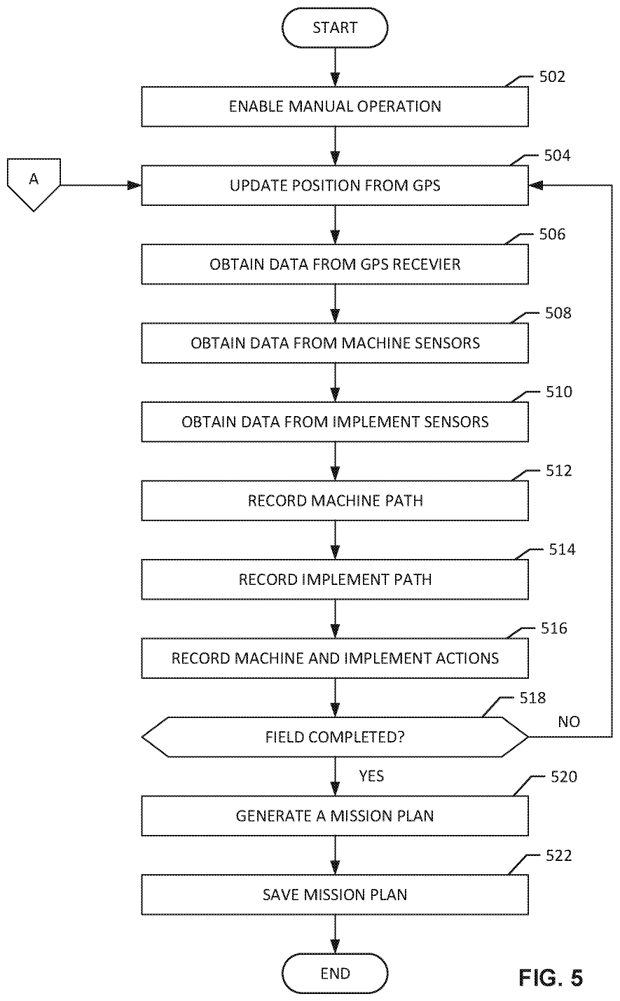

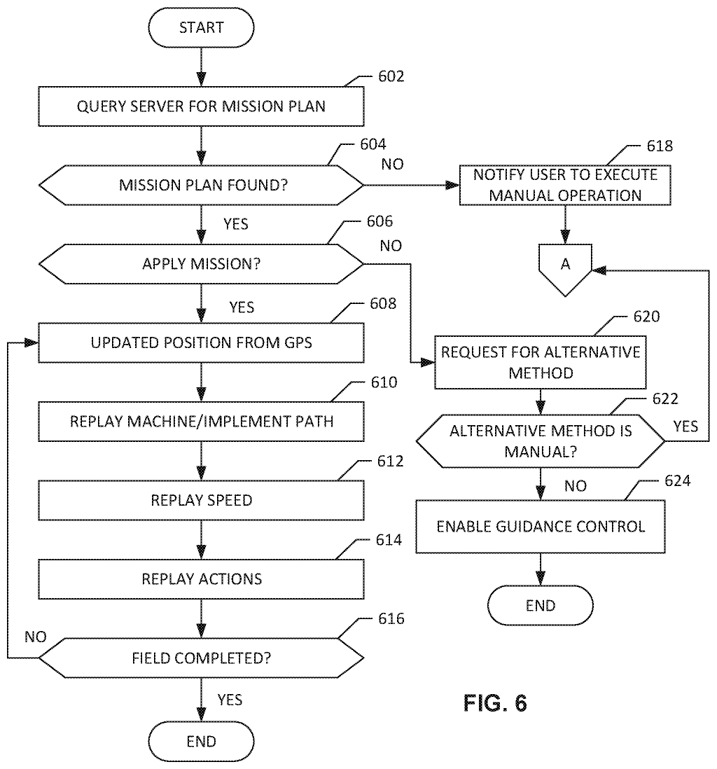

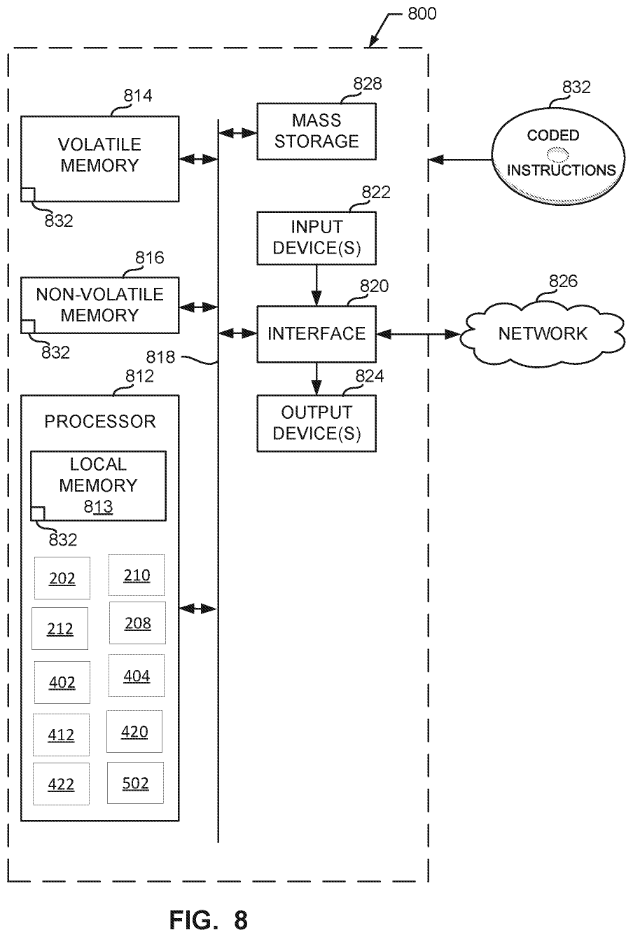

Flowcharts representative of example hardware logic, machine readable instructions, hardware implemented state machines, and/or any combination thereof for implementing the mission planning system 116 of FIG. 1B are shown in FIGS. 5-7. The machine readable instructions may be one or more executable programs or portion(s) of an executable program for execution by a computer processor and/or processor circuitry, such as the processor 812 shown in the example processor platform 800 discussed below in connection with FIG. 8. The programs may be embodied in software stored on a non-transitory computer readable storage medium such as a CD-ROM, a floppy disk, a hard drive, a DVD, a Blu-ray disk, or a memory associated with the processor 812, but the entire program and/or parts thereof could alternatively be executed by a device other than the processor 812 and/or embodied in firmware or dedicated hardware. Further, although the example programs are described with reference to the flowcharts illustrated in FIGS. 5-7, many other methods of implementing the example mission planning system 116 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more devices (e.g., a multi-core processor in a single machine, multiple processors distributed across a server rack, etc).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement one or more functions that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example processes of FIGS. 5-7 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

The mission recording program of FIG. 5 begins at block 502 in which the example machine 102 enables manual operation. For example, the user may decide to manually operate the machine 102 and deactivate the self-steering and self-driving operations. The example user interface 202 updates the position of the machine 102 and implement 104 from the example receivers 112, 114 (block 504). For example, the user may select the fields input 306 to inform the mission planning system 116 where (e.g., what location) the mission plan will take place.

The user begins the agricultural operation and the example data collection memory 216 obtains data from the receivers 112, 114 (block 506). For example, when the machine 102 and/or implement 104 moves in any direction (e.g., east to west, north to south, and up or down) the example receivers 112, 114 record the movement, velocity, and time of that movement. The example data collection memory 216 obtains data from the machine sensors 118 (block 508). The example data collection memory 216 obtains data from the implement sensors 120 (block 510). For example, the machine sensors 118A and 118B may monitor temperature of the components of the machine 102 and the machine data controller 402 retrieves that data from the data collection memory 216 to use to determine any relevant information corresponding to the mission plan. In some examples, the implement sensors 120A and 120B may measure acceleration of the implement 104 and implement data controller 404 may retrieve the acceleration data from the data collection memory 216 to use the to determine relevant information corresponding to the mission plan such as if the implement 104 was raised or lowered and at what location.

The example mission recording controller 208 records the machine 102 path (block 512) and records the implement 104 path (block 514). For example, when the data collection memory 216 stores the data from the receivers 112, 114 (block 506), the mission planning system 116 is recording (e.g., saving in a memory) the location data. The example mission recording controller 208 records the machine 102 and implement 104 actions (block 516). For example, the data collection memory 216 obtains data from the sensors 118, 120 and records (e.g., saves in a memory) the time and data from the sensors 118, 120 for the mission aggregator 406 and the mission generator 210 to interpret as actions when creating the mission plan. The data from the example sensors 118, 120 is indicative of the actions taken by the machine 102 and implement 104.

The example field monitoring controller 218 determines if the field plot 100 is completed (block 518). For example, after the data collection memory 216 provides the data to the mission recording controller 208 to separate the data of the receivers 112, 114 and the sensors 118, 120 into a machine data controller 402 and an implement data controller 404, the mission aggregator 406 organizes the data into a format in which creates a layout. In this manner, the example mission aggregator 406 requests information from the field monitoring controller 218 to determine if the field plot 100 is complete. In other examples, the mission aggregator 406 queries the example field monitoring controller 218 for information corresponding to the area in which the machine 102 has traversed to determine if that area equals the area of the field plot 100 indicated by the user at block 504.

If the example field monitoring controller 218 determines that the field has been completed (block 518), the example mission aggregator 406 provides the aggregated data to the example mission generator 210. The example mission generator 210 generates a mission plan 408 (block 520). For example, the mission generator 210 creates a 3D map including informational sections about the machine and implement (e.g., actions, speed, etc.), guidance lines taken by the machine 102 and the implement 104, and a map of the terrain (e.g., field plot 100) in which the machine 102 and implement 104 traversed. The example mission generator 210 saves the mission plan 408 (block 522) in the example local database 206 for future use by the user. If the example field monitoring controller 218 determines the field has not been completed at block 518, then control returns to block 504.

The mission executing program begins at block 602 (FIG. 6) when the example user interface 202 provides an instruction to query the example local database 206 for a mission plan. The mission plan increases efficiency for the user performing an agricultural operation. The example user interface 202 determines if the mission plan is found (block 604). For example, if the user interface 202 determines that the mission plan has not been found in the local database 206, then the user interface 202 notifies the user to execute manual operation (block 518). For example, the user interface 202 may provide a notification box with character strings including “Mission plan not found. Please perform manual operation.” When the user executes manual operation (block 618) process returns to block 504 (FIG. 5) where the example user interface 202 updates the position of the machine 102 and implement 104 from the example receivers 112, 114 to record the mission of the agricultural operation the user performs on the field plot 100.

In some examples, if the local database 206 provides the mission application controller 212 with the mission plan, then the user interface 202 receives a notification that the mission plan is found (block 604). The example user interface 202 determines if the user wants to apply the mission plan (block 606). For example, the user may determine, based on the information provided in the mission plan, that the mission plan previously recorded used different working widths. In such an example, the user cannot apply this mission plan. The example user interface 202 requests for alternative method (block 620). The example user interface 202 provides a notification to the user via the user interface display and asks the user if they want to perform manual operation or an automated operation. As used herein, an automated operation is defined as an autonomous machine operating without the assistance of a user such as a farmer, an operator, a professional tractor driver, etc.

At block 622, the example user interface 202 determines if the alternative method selected by the user is manual operation. If the alternative method is manual operation, control returns to block 504 (FIG. 5). In some examples, if the user interface 202 determines the alternative method is not manual operation, then it must be automated operation. In this manner, the example user interface 202 enables guidance control (block 624) of the autonomous machine. For example, the interactive guidance input 310 may be enabled to steer the machine 102 through the field plot 100 along the guidance tracks set by the set track input 312. The process ends at block 624 when the example user interface 202 enables guidance control.

In other examples, if the user determines they can apply the mission plan at block 606, the user interacts with the user interface 202 instructing this request. The example mission application controller 212 notifies the example receivers 112, 114 to update the position (block 608).

The example mission applicator replays the machine 102 path and implement 104 path (block 610). For example, the mission application controller 212 analyzes the bundle of data in the mission plan and, based on the time of the location data, replays the guidance lines created from start to finish. The example mission application controller 212 replays the speed of the example machine 102 (block 612) and the actions of the example implement 104 (block 614). For example, the mission application controller 212 provides instructions to the operating hardware of the implement 104 to raise a planter bar coupled to the machine 102 when the machine 102 is making a turn in the field plot 100.

The example field monitoring controller 218 determines if the field has been completed (block 616). For example, when the implement 104 performs an action as instructed by the mission application controller 212, the field monitoring controller 218 queries the data collection memory 216 to determine if the mission plan has been completed, such as if that was the action with the latest time stamp in which would be the last action to be performed on the field plot 100. If the example field monitoring controller 218 determines the field has not been completed (block 616), then control returns to block 608. If the example field monitoring controller 218 determines the field has been complete (block 616), the process ends.

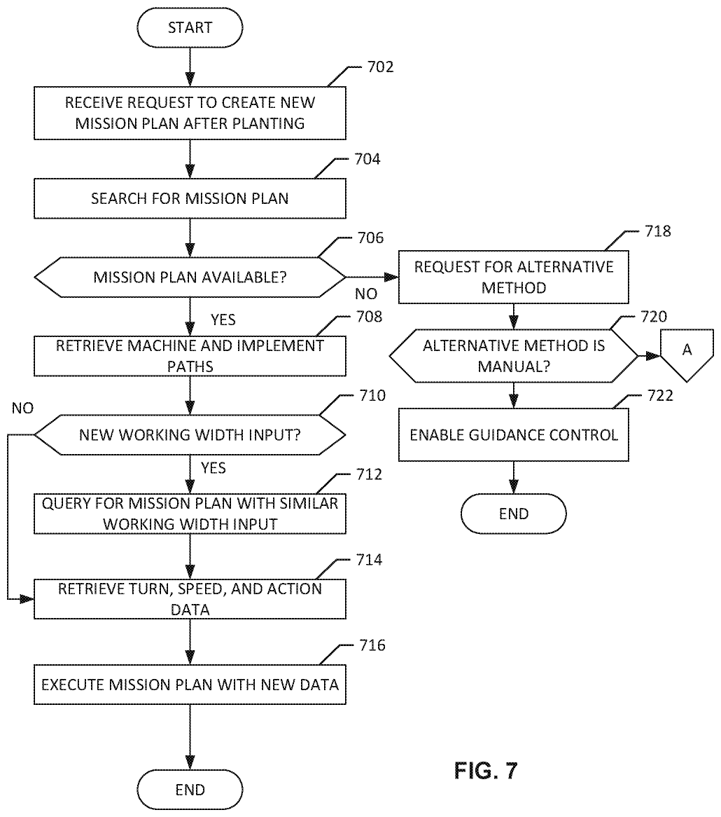

FIG. 7 illustrates machine-readable instructions that create a new mission plan. The machine-readable instructions of FIG. 7 begins at block 702 (FIG. 7) wherein the mission recording controller 208 receives an instruction from the user interface 202 to create new mission plan after planting. For example, there is a crop rotation every year on the field plot 100 of corn and soybean. For the first year, corn is planted in the example field plot 100 and the path is recorded for that mission. In the second year, a user wants to plant soybean in the example field plot 100 and use the mission plan recorded in the first year, but the implement 104 used to plant the corn is a different size than the implement used to plant soybean. In this manner, the recorded path for corn is a larger width than the path for soybean. So a user determines they want to create a new mission plan after planting.

At block 704, the example user interface 202 queries the local database 206 to search for the mission plan 408. The example user interface 202 determines if there is a mission plan available (block 706) by receiving a notification from the local database 206 indicative of mission plan availability. If the example local database 206 does not provide a notification indicative of a mission plan availability (block 706), the example user interface 202 requests for alternative method (block 718). The example user interface 202 provides a notification to the user via the user interface display and asks the user if they want to perform manual operation or an automated operation.

At block 720, the example user interface 202 determines if the alternative method selected by the user is manual operation. If the alternative method is manual operation, control returns to block 504 (FIG. 5). In some examples, if the user interface 202 determines the alternative method is not manual operation, then it must be automated operation. In this manner, the example user interface 202 enables guidance control (block 722) of the autonomous machine. For example, the interactive guidance input 310 may be enabled to steer the machine 102 through the field plot 100 along the guidance tracks set by the set track input 312. The process ends at block 722 when the example user interface 202 enables guidance control.

At block 706, if the mission plan 408 is available, the user interface 202 retrieves machine 102 path and implement 104 path (block 708) from the bundle of data and provides it to the user interface display. On the display, the user will see the working width (e.g., the width of the planting rows) and the user interface 202 will prompt the user to determine if this mission requires a new working width input (block 710). For example, the user interface 202 may display the working width as a value of inches, meters, centimeters, feet, etc. in a section of the user interface display. If the example user interface 202 receives a notification indicating the working width input is new (e.g., different than the working width input of the downloaded mission plan), the example user interface 202 generates an instruction to query the local database 206 for a mission plan including similar working width inputs (block 712).

The example mission application controller 212 obtains turn, speed, and action data (block 714) from the mission plan stored in the local database 206. For example, when creating a new mission plan, the user is provided with the data from the previously recorded mission plan including the speed, actions, and machine 102 and implement 104 paths. After reviewing the data, the user may provide an input to the example user interface 202 such as a new speed (e.g., the machine 102 may move faster during spraying chemicals and slower during panting or vice versa), new turns (e.g., if there are fewer crop rows for soybean than there were for corn, then more turns may be added), and new actions (e.g., if more turns are added then more actions to raise and lower the implement are required). Therefore, the user interface 202 retrieves this data to provide to the example mission application controller 212.

The example mission application controller 212 executes the mission plan with the new data (block 716). For example, the mission application controller 212 may obtain the new mission plan from the local database 206 and apply the bundle of instructions to the hardware operating the machine 102, the machine receiver 112, the implement receiver 114, and/or the hardware operating the implement 104.

At block 710, if the user determines there is not a new working width input, the user will interact with the user interface 202 display instructing the system that the previous working width is correct and can be used for that mission. If the user interface 202 has been instructed that the working width is correct, the process turns to block 714 wherein the mission application controller 212 retrieves turn, speed, and action. When the new mission plan is executed, the process to create new mission plan ends.

FIG. 8 is a block diagram of an example processor platform 800 structured to execute the instructions of FIGS. 5-7 to implement the apparatuses of FIGS. 2 and 4. The processor platform 800 can be, for example, a server, a personal computer, a workstation, a self-learning machine (e.g., a neural network), a mobile device (e.g., a cell phone, a smart phone, a tablet such as an iPad™), an Internet appliance, a digital video recorder, a personal video recorder, or any other type of computing device.

The processor platform 800 of the illustrated example includes a processor 812. The processor 812 of the illustrated example is hardware. For example, the processor 812 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example user interface 202, the example mission recording controller 208, the example mission generator 210, the example mission application controller 212, the example machine receiver 112, the example implement receiver 114, the example mission aggregator 406, and the example field monitoring controller 218.

The processor 812 of the illustrated example includes a local memory 813 (e.g., a cache). The processor 812 of the illustrated example is in communication with a main memory including a volatile memory 814 and a non-volatile memory 816 via a bus 818. The volatile memory 814 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 816 may be implemented by flash memory and/or any other desired type of memory device. Access to the main memory 814, 816 is controlled by a memory controller.

The processor platform 800 of the illustrated example also includes an interface circuit 820. The interface circuit 820 may be implemented by any type of interface standard, such as an Ethernet interface, a universal serial bus (USB), a Bluetooth® interface, a near field communication (NFC) interface, and/or a PCI express interface.

In the illustrated example, one or more input devices 822 are connected to the interface circuit 820. The input device(s) 822 permit(s) a user to enter data and/or commands into the processor 812. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 824 are also connected to the interface circuit 820 of the illustrated example. The output devices 824 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 820 of the illustrated example, thus, typically includes a graphics driver card, a graphics driver chip and/or a graphics driver processor.

The interface circuit 820 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 826. The communication can be via, for example, an Ethernet connection, a digital subscriber line (DSL) connection, a telephone line connection, a coaxial cable system, a satellite system, a line-of-site wireless system, a cellular telephone system, etc.

The processor platform 800 of the illustrated example also includes one or more mass storage devices 828 for storing software and/or data. Examples of such mass storage devices 828 include floppy disk drives, hard drive disks, compact disk drives, Blu-ray disk drives, redundant array of independent disks (RAID) systems, and digital versatile disk (DVD) drives.

The machine executable instructions 832 of FIGS. 5-7 may be stored in the mass storage device 828, in the volatile memory 814, in the non-volatile memory 816, and/or on a removable non-transitory computer readable storage medium such as a CD or DVD.

From the foregoing, it will be appreciated that example methods, apparatus and articles of manufacture have been disclosed that implement a practical solution to solve the problem of erroneously executing a mission plan when natural contours (e.g., slopes and hills) of a field plot are unknown by leveraging computing devices to record and execute 3D mission plans in an agricultural environment for future use by a machine operator, wherein such natural contours make it difficult for a non-professional operator to perform on without the mission plan. The disclosed methods, apparatus and articles of manufacture improve the efficiency of using a computing device by reducing the error implement actions create when underperforming the implement and machine due to inexperience and geographical displacement of a field plot. The disclosed methods, apparatus and articles of manufacture are accordingly directed to one or more improvement(s) in the functioning of a computer.

Example methods, apparatus, systems, and articles of manufacture to record and execute mission plans are disclosed herein. Further examples and combinations thereof include the following:

Example 1 includes an apparatus to record a mission plan of an agricultural field comprising a data collection memory to collect first and second data, via a network, wherein the first data corresponds to a machine and the second data corresponds to an implement, a mission aggregator to determine a machine path based on the first data, determine an implement path based on the second data, and determine a machine speed and an implement action based on the first and second data, a mission generator to generate a three-dimensional (3D) report including the machine path, the implement path, the machine speed, and the implement action, wherein the report is a mission plan stored in a database for use by the machine and the implement for a subsequent operation, and a mission application controller to, when an interface determines the mission plan is available, instruct the machine and the implement to follow the machine path, the implement path, the machine speed, and the implement action to execute the mission plan.

Example 2 includes the apparatus of example 1, further including a first receiver coupled to the machine and a second receiver coupled to the implement, wherein the first receiver records the machine path and the second receiver records the implement path.

Example 3 includes the apparatus of example 2, wherein the first receiver records a z position corresponding to an altitude of the machine and the second receiver records the z position corresponding to an altitude of the implement.

Example 4 includes the apparatus of example 3, wherein the mission plan is a 3D map including a visual representation of slopes and hills of the agricultural field.

Example 5 includes the apparatus of example 1, wherein the 3D report is to be accessed by an operator performing the subsequent operation on the agricultural field.

Example 6 includes the apparatus of example 1, further including a field monitoring controller to determine a time the mission plan will be complete.

Example 7 includes the apparatus of example 6, wherein the field monitoring controller notifies an interface when the machine and the implement complete the mission plan of the agricultural field.

Example 8 includes a non-transitory computer readable storage medium comprising instructions that, when executed, cause one or more processors to at least collect first and second data, via a network, wherein the first data corresponds to a machine and the second data corresponds to an implement, determine a machine path based on the first data, determine an implement path based on the second data, and determine a machine speed and an implement action based on the first and second data, generate a three-dimensional (3D) report including the machine path, the implement path, the machine speed, and the implement action, wherein the report is a mission plan stored in a database for use by the machine and the implement for a subsequent operation, and instruct, when an interface determines the mission plan is available, the machine and the implement to follow the machine path, the implement path, the machine speed, and the implement action to execute the mission plan.

Example 9 includes the non-transitory computer readable storage medium of example 8, wherein the instructions, when executed, cause the one or more processors to record the machine path and the record the implement path.

Example 10 includes the non-transitory computer readable storage medium of example 8, wherein the instructions, when executed, cause the one or more processors to record a z position corresponding to an altitude of the machine and the z position corresponding to an altitude of the implement.

Example 11 includes the non-transitory computer readable storage medium of example 8, wherein the instructions, when executed, cause the one or more processors to generate the mission plan as a 3D map including a visual representation of slopes and hills of an agricultural field.

Example 12 includes the non-transitory computer readable storage medium of example 8, wherein the instructions, when executed, cause the one or more processors to determine a time the mission plan will be complete.

Example 13 includes the non-transitory computer readable storage medium of example 8, wherein the instructions, when executed, cause the one or more processors to notify an interface when the machine and the implement complete the mission plan of an agricultural field.

Example 14 includes a method to record a mission plan of an agricultural field comprising collecting first and second data, via a network, wherein the first data corresponds to a machine and the second data corresponds to an implement, determining a machine path based on the first data, determining an implement path based on the second data, and determining a machine speed and an implement action based on the first and second data, generating a three-dimensional (3D) report including the machine path, the implement path, the machine speed, and the implement action, wherein the report is a mission plan stored in a database for use by the machine and the implement for a subsequent operation, and instructing, when an interface determines the mission plan is available, the machine and the implement to follow the machine path, the implement path, the machine speed, and the implement action to execute the mission plan.

Example 15 includes the method of example 14, further including recording the machine path and recording the implement path.

Example 16 includes the method of example 14, further including recording a z position corresponding to an altitude of the machine and the z position corresponding to an altitude of the implement.

Example 17 includes the method of example 14, further including generating the mission plan as a 3D map including a visual representation of slopes and hills of a agricultural field.

Example 18 includes the method of example 14, further including determining a time the mission plan will be complete.

Example 19 includes the method of example 14, further including notifying an interface when the machine and the implement complete the mission plan of the agricultural field.

Example 20 includes the method of example 14, further including providing the 3D report to an operator performing the subsequent operation on the agricultural field.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

The following claims are hereby incorporated into this Detailed Description by this reference, with each claim standing on its own as a separate embodiment of the present disclosure.

What is claimed is:

1. An apparatus to record a mission plan of an agricultural field comprising:
a data collection memory to collect first and second data, via a network, wherein the first data corresponds to a machine and the second data corresponds to an implement;
a mission aggregator to:
determine a machine path based on the first data;
determine an implement path based on the second data; and
determine a machine speed and an implement action based on the first and second data;
a mission generator to generate a three-dimensional (3D) report including the machine path, the implement path, the machine speed, and the implement action, wherein the report is a mission plan stored in a database for use by the machine and the implement for a subsequent operation; and
a mission application controller to, when an interface determines the mission plan is available, instruct the machine and the implement to follow the machine path, the implement path, the machine speed, and the implement action to execute the mission plan.

2. The apparatus of claim 1, further including a first receiver coupled to the machine and a second receiver coupled to the implement, wherein the first receiver records the machine path and the second receiver records the implement path.

3. The apparatus of claim 2, wherein the first receiver records a z position corresponding to an altitude of the machine and the second receiver records the z position corresponding to an altitude of the implement.

4. The apparatus of claim 3, wherein the mission plan is a 3D map including a visual representation of slopes and hills of the agricultural field.

5. The apparatus of claim 1, wherein the 3D report is to be accessed by an operator performing the subsequent operation on the agricultural field.

6. The apparatus of claim 1, further including a field monitoring controller to determine a time the mission plan will be complete.

7. The apparatus of claim 6, wherein the field monitoring controller notifies an interface when the machine and the implement complete the mission plan of the agricultural field.

8. A non-transitory computer readable storage medium comprising instructions that, when executed, cause one or more processors to at least:
collect first and second data, via a network, wherein the first data corresponds to a machine and the second data corresponds to an implement;
determine a machine path based on the first data;
determine an implement path based on the second data; and
determine a machine speed and an implement action based on the first and second data;
generate a three-dimensional (3D) report including the machine path, the implement path, the machine speed, and the implement action, wherein the report is a mission plan stored in a database for use by the machine and the implement for a subsequent operation; and
instruct, when an interface determines the mission plan is available, the machine and the implement to follow the machine path, the implement path, the machine speed, and the implement action to execute the mission plan.

9. The non-transitory computer readable storage medium of claim 8, wherein the instructions, when executed, cause the one or more processors to record the machine path and the record the implement path.

10. The non-transitory computer readable storage medium of claim 8, wherein the instructions, when executed, cause the one or more processors to record a z position corresponding to an altitude of the machine and the z position corresponding to an altitude of the implement.

11. The non-transitory computer readable storage medium of claim 8, wherein the instructions, when executed, cause the one or more processors to generate the mission plan as a 3D map including a visual representation of slopes and hills of an agricultural field.

12. The non-transitory computer readable storage medium of claim 8, wherein the instructions, when executed, cause the one or more processors to determine a time the mission plan will be complete.

13. The non-transitory computer readable storage medium of claim 8, wherein the instructions, when executed, cause the one or more processors to notify an interface when the machine and the implement complete the mission plan of an agricultural field.

14. A method to record a mission plan of an agricultural field comprising:
collecting first and second data, via a network, wherein the first data corresponds to a machine and the second data corresponds to an implement;
determining a machine path based on the first data;
determining an implement path based on the second data; and
determining a machine speed and an implement action based on the first and second data;
generating a three-dimensional (3D) report including the machine path, the implement path, the machine speed, and the implement action, wherein the report is a mission plan stored in a database for use by the machine and the implement for a subsequent operation; and
instructing, when an interface determines the mission plan is available, the machine and the implement to follow the machine path, the implement path, the machine speed, and the implement action to execute the mission plan.

15. The method of claim 14, further including recording the machine path and recording the implement path.

16. The method of claim 14, further including recording a z position corresponding to an altitude of the machine and the z position corresponding to an altitude of the implement.

17. The method of claim 14, further including generating the mission plan as a 3D map including a visual representation of slopes and hills of a agricultural field.

18. The method of claim 14, further including determining a time the mission plan will be complete.

19. The method of claim 14, further including notifying an interface when the machine and the implement complete the mission plan of the agricultural field.

20. The method of claim 14, further including providing the 3D report to an operator performing the subsequent operation on the agricultural field.
